(19) United States
(12) Patent Application Publication
(10) Pub. No.: US 2022/0352833 A1
(43) Pub. Date: Nov. 3, 2022

(54) REDUNDANT BRUSHLESS DIRECT CURRENT MOTOR CONTROL SYSTEM AND RELATED METHODS

(71) Applicant: NEUTRON AUTOMOTIVE CONTROLS INC., Ottawa (CA)

(72) Inventors: Alexandre GOURARI, Toronto (CA); Thomas Willem BRAKEL, Gatineau (CA); Vladimir PANCHENKO, Ottawa (CA); John Joseph WOJTKOWICZ, Yarker (CA)

(73) Assignee: NEUTRON AUTOMOTIVE CONTROLS INC., Ottawa, ON (CA)

(21) Appl. No.: 17/760,516

(22) PCT Filed: Sep. 15, 2020
(86) PCT No.: PCT/CA2020/051241

§ 371 Date: Mar. 15, 2022

Related U.S. Application Data
(60) Provisional application No. 62/900,934, filed on Sep. 16, 2019.

(30) Foreign Application Priority Data
Sep. 17, 2019 (CA) 3,055,662

(51) Int. Cl. H02P 5/74; H02P 6/04

(52) U.S. Cl. CPC H02P 5/74; H02P 6/04; B60R 16/0231

(57) ABSTRACT

Brushless direct current (BLDC) motors are becoming more common, such as in cars and other vehicles. Unreliable BLDC motors or control systems can lead to risk of people's safety. A redundant BLDC control system is provided to control two or more BLDC motors. A safety module controls an enabling switch in each of the motor drivers, so that in response to detecting a fault condition, a currently active BLDC motor is disabled and a redundant BLDC motor is enabled. A digital processor computes and transmits digital signals to all the motor drivers continuously and simultaneously, so that the transition from a currently active BLDC motor to a redundant BLDC motor is smooth and almost unnoticeable.

### CROSS-REFERENCE TO RELATED APPLICATIONS

This patent application claims priority to U.S. Patent Application No. 62/900,934 filed on Sep. 16, 2019 and titled “Redundant Brushless Direct Current Motor Control System and Related Methods”, and to Canadian Patent Application No. 3,055,662 filed on Sep. 17, 2019 and titled “Redundant Brushless Direct Current Motor Control System and Related Methods”, the entire contents of which are herein incorporated by reference.

### TECHNICAL FIELD

The following generally relates to a redundant brushless direct current motor control system and related methods.

### DESCRIPTION OF THE RELATED ART

Brushless Direct Current (DC) electric motors, also referred to as BLDC motors or BL motors, are used in various applications including automotive vehicles, electric vehicles, hybrid vehicles, personal transporters, motion control systems, heating and ventilation, actuation systems, and industrial automation. For example, in relation to vehicles, BLDC motors are used to provide motive force for vehicles. BLDC motors are used in steering systems for vehicles. It will be appreciated that BLDC motors are used in various parts of vehicles, amongst other applications.

The BLDC motor has a permanent-magnet rotor surrounded by a wound stator. The winding in the stator get commutated electronically, instead of with brushes. BLDC motors are preferred because of their high power efficiency, high speed, electronic control, and robustness.

### BRIEF DESCRIPTION OF THE DRAWINGS

Embodiments will now be described by way of example only with reference to the appended drawings wherein:

FIG. 1 is a schematic diagram of a known example of a three-phase BLDC motor.

FIG. 2 is a schematic diagram of a known example of a six-phase BLDC motor.

FIG. 3 is a schematic diagram of two BLDC motors driving a common shaft controlled by a redundant controller, according to an example embodiment.

FIG. 4 is a schematic diagram of two BLDC motors driving their respective shafts that have been mechanically coupled together, and the BLDC motors are controlled by a redundant controller, according to an example embodiment.

FIG. 5 is a schematic diagram of two BLDC motors controlled by a redundant controller, which includes two motor drivers that are controlled by a microcontroller unit (MCU) and safety module, according to an example embodiment.

FIG. 6 is a schematic diagram similar to FIG. 5, but with the safety module incorporated into the MCU, according to an example embodiment.

FIG. 7 is a schematic diagram similar to FIG. 5, but with the safety module and the two motor drivers incorporated into one control unit, according to an example embodiment.

FIG. 8 is a flow diagram of executable instructions or processor implemented instructions for controlling power to two or more BLDC motors according to an example embodiment.

FIG. 9 is a flow diagram of executable instructions or processor implemented instructions for the safety module to determine which BLDC motor to enable or disable according to an example embodiment.

FIG. 10 is a flow diagram of executable instructions or processor implemented instructions for the safety module to determine when to activate a redundant BLDC motor at the same time as a primary BLDC motor, according to an example embodiment.

FIG. 11 is a schematic diagram of two BLDC motors coupled together to drive a gear box, which in turn drives a drive shaft, according to an example embodiment.

FIG. 12 is a schematic diagram of three or more BLDC motors coupled to a common shaft and are controlled by a redundant controller, according to an example embodiment.

FIG. 13 is a schematic diagram of three more BLDC motors each driving their respective shafts that are coupled together, and the BLDC motors are controlled by a redundant controller, according to an example embodiment.

FIG. 14 is a schematic diagram similar to FIG. 12, but showing a specific implementation of the redundant controller, according to an example embodiment.

FIG. 15 is a schematic diagram of a system that includes four nodes wired using redundant communications to detect and propagate a condition in the system, and switch from enabling a first BLDC motor to enabling a second BLDC motor in the system, according to an example embodiment.

FIG. 16 is a flow diagram of executable instructions or processor implemented instructions for propagating and controlling the redundant BLDC motors controllable by different nodes in the system shown in FIG. 15, according to an example embodiment.

FIG. 17 is a schematic diagram of a system that includes six nodes wired using redundant communications, including a first companion pair of nodes that control two redundant BLDC motors and a second companion pair of nodes that control another two redundant BLDC motors.

FIG. 18 is a schematic diagram of an assembled kit of parts of a main computing board that includes slots that connect with two or more motor drivers for controlling BLDC motors, according to an example embodiment. For example, this is used to model and develop a redundant BLDC control system using the principles described herein.

FIG. 19 is a schematic diagram of a BLDC motor that includes a first and a second three-phase coils system that are connected to a common stator and that drive a common shaft, a redundant controller is able to control the first three-phase coil system independently from the second three-phase coil system.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

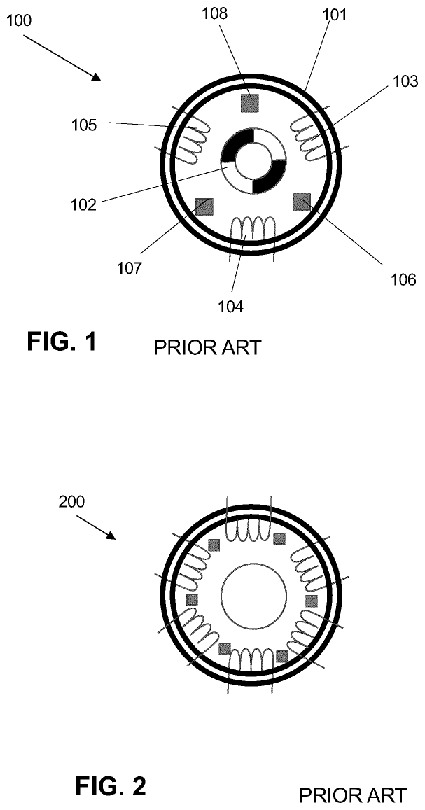

Turning to FIG. 1, a known example of a three-phase BLDC motor 100 is shown. It includes a stator 101, a rotor 102, three coils 103, 104, 105, and three Hall effect sensors 106, 107, 108. A controller, not shown here, pulses current through the coils 103, 104, 105 to generate electric fields that interact with the rotor 102 and cause the rotor to spin. The Hall effect sensors 106, 107, 108 provide feedback about the rotor's position.

As BLDC motors become more widely adopted, BLDC motors are being applied in critical systems that require better fail-safe operations. For example, BLDC motors are being used in critical systems for cars and aircraft, to name a few vehicles. Failure or a fault of a BLDC motor could lead to a vehicle (e.g. a car, an airplane, etc.) to fail in a dangerous way. For example, the vehicle could crash, hurt someone, or cause damage. Therefore, it is herein recognized that providing a reliable BLDC motor system is important.

FIG. 2 shows a six-phase BLDC motor 200 that includes six coils in order to help increase reliability. For example, if one of the coils is damaged or the specified current flowing to one of the coils is hindered, then the other coils are there to continue to provide motive force to the rotor. In other examples to help improve reliability, there are BLDC motors that have nine coils (e.g. nine phases). In other words, one approach to increase reliability is to increase the number of phases of a BLDC motor. However, it is herein recognized that damage to the BLDC motor 200 still leads to a lower performance of the BLDC motor 200. Furthermore, BLDC motors that have more than three phases are more expensive. Furthermore, control systems for a six phase or nine phase BLDC motor are more complex and more expensive.

By contrast, it is herein recognized that a three phase BLDC motor 100 is not as expensive and has more robust and simpler controls.

Therefore, in an example embodiment, two or more three-phase BLDC motors are coupled together to provide redundancy and a redundant control system controls the two or more three-phase BLDC motors.

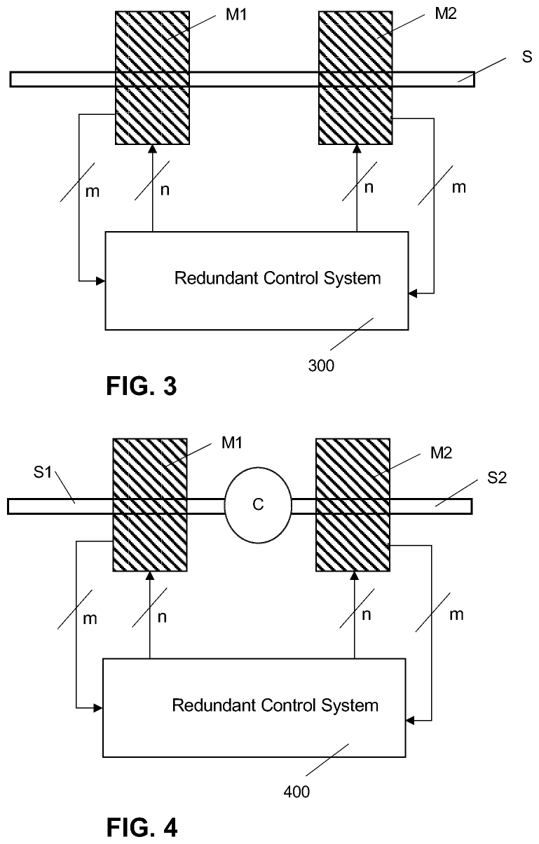

Turning to FIG. 3, an example embodiment is herein provided of two BLDC motors M1, M2 coupled to a common drive shaft S. The redundant controller 300 sends current through n electrical lines to respectively energize n coils in the BLDC motor M1, where n is a natural number. The redundant controller 300 also sends current through n electrical lines to respectively energize n coils in the BLDC motor M2. In an example aspect, the BLDC motors M1 and M2 are the same. In an example aspect, n is 3, so that each BLDC motor has three coils corresponding to three phases. While using a BLDC motor that has three coils is desirable due to cost effectiveness, it will be appreciated that the number of coils n in each BLDC motor can be different than 3.

In an example aspect, each of the BLDC motors M1, M2 have m Hall effect sensors, where m is a natural number. The data from these m sensors are fed back to the redundant control system 300. In an example aspect, m is the same as n, although not necessarily.

FIG. 4 is a similar embodiment to FIG. 3. However, the BLDC motor M1 drives a shaft S1 and the BLDC motor M2 drives another shaft S2. The shafts S1 and S2 are coupled together by a coupling C. The coupling C can be linked to another mechanism. The redundant control system 400 drives both BLDC motors, for example, in the same direction or in opposing directions.

In an example embodiment, the redundant control systems 300, 400 enable current to flow to only one BLDC motor at a time with near instantaneous switching between different BLDC motors in order to provide smooth and reliable operation. For example, while BLDC motor M1 is running, BLDC motor M2 is off. If a fault or anomaly is detected in BLDC motor M1, then redundant controller disables BLDC motor M1 and enables BLDC motor M2.

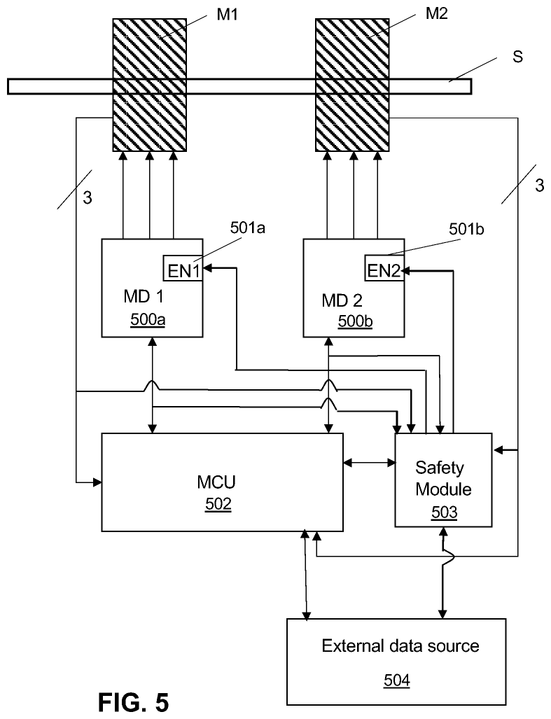

Turning to FIG. 5, an example embodiment similar to FIG. 3 is provided, showing further detail about an example redundant control system. In particular, a first motor driver 500a, also herein referred to as MD1, controls the activation and current flow to the BLDC motor M1 via three power lines. The first motor driver 500a also includes an enable module 501a (also herein called EN1) that enables or disables the flow of current from the first motor driver 500a to the BLDC motor M1.

In an example aspect, the first motor driver 500a is a power system that receives digital signals from a digital processor (e.g. a micro controller unit (MCU), a digital signal processor (DSP), a field programmable gate array (FPGA), etc.), and then accordingly outputs sufficient DC power at different power lines to energize different coils in the first BLDC motor M1. The first motor driver 500a typically includes amplifiers or a semiconductor power commutator, amongst other things.

In an example aspect, the first motor driver 500a also includes its own current controller to control the current output, and the current controller uses the digital signals to compute and control the current outputs.

In another example aspect, the first motor driver 500a includes circuitry for detecting one or more of: over-temperature, over-current and under-voltage, amongst other conditions.

A similar configuration exists between BLDC motor M2 and the second motor driver 500b, also herein referenced as MD2. The second motor driver 500b also includes its own enable module 501b (also herein called EN2) that enables or disables the flow of current from the second motor driver 500b to the BLDC motor M2. The second motor driver 500b is the same or similar to the first motor driver 500a. In an example aspect, the enable modules EN1 501a and EN2 501b operate like switches to control the current flow.

A MCU 502 controls both the motor drivers 500a, 500b. A safety module 503 is in data communication with the MCU 502, both of the motor drivers 500a, 500b, and receives the feedback data from the Hall sensors in the BLDC motors M1 and M2. For example, three data lines from the BLDC motor M1 transmit Hall effect sensor data to the MCU 502. The safety module 503 also controls the enable modules 501a and 501b. In particular, the safety module obtains data from the MCU, the Hall sensors and the motor drivers to determine which of the enable modules 501a and 501b should be enabled and disabled. In other words, the safety module can control whether the coils in the BLDC motor M1 are enabled or disabled, and the safety module can control whether the coils in the BLDC motor M2 are enabled or disabled.

In another example aspect, an external data source or external device 504 provides data to the MCU 502 or the safety module 503, or both, about data relating to one or more operating parameters of the BLDC motors M1, M2 or the motor drivers M1, M2, or a combination thereof. In particular, a faulty operating parameter originates from a device external to the BLDC motors, such as an external sensor, an electronic control unit (ECU), or some other processor node. Examples of external sensors include: a temperature sensor, a pressure sensor, a humidity sensor, a wetness sensor, a stress sensor, a speed sensors, a position sensor, etc. In an example, embodiment, two motors M1, M2 are connected to a wheel; if it is detected that the wheel is stuck or cannot move, then the second motor is activated to try and drive the wheel. In another example, the one or more parameters relate to an internal operating parameter of one or both of the BLDC motors M1, M2.

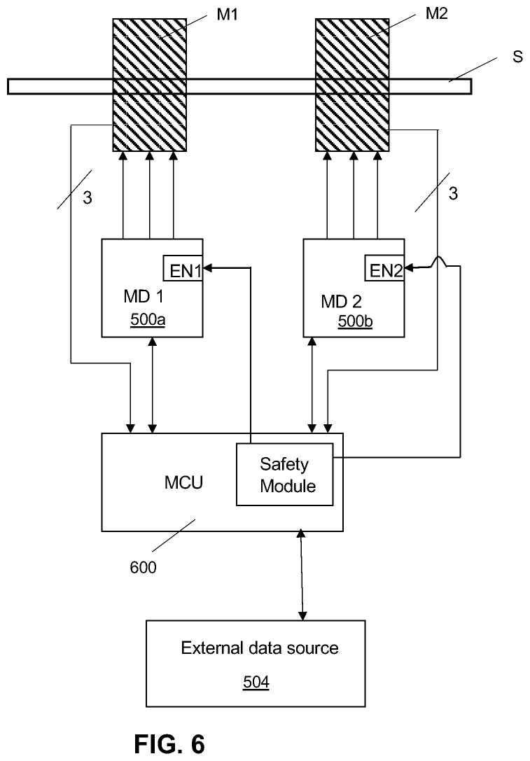

In the example shown in FIG. 5, the components 500a, 500b, 502 and 503 are separate electronic devices. However, in FIG. 6, an alternative example embodiment is shown in which the safety module is integrated into the MCU as a sub-component or as software. This combined electronic device 600 that includes the safety module integrated into the MCU controls separate components of the first and the second motor drivers 500a, 500b.

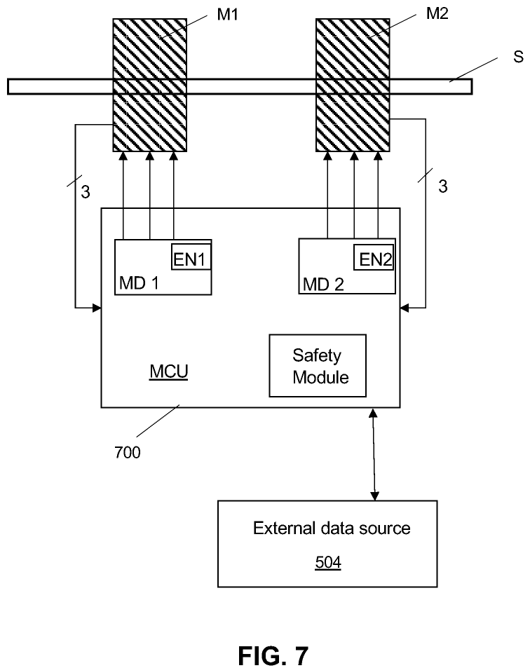

FIG. 7 shows another alternative example embodiment in which an electronic device 700 that has integrated into it the MCU, the safety module, and both motor drivers for the BLDC motors. In an example embodiment, the safety module and both motor drivers are implemented within the MCU.

As shown in FIGS. 5 to 7, the configuration of the redundant control system 300 can be implemented in different ways. It will be appreciated that the example configurations of a redundant control system in FIGS. 5 to 7 are shown in relation to two BLDC motors that drive a common shaft S. However, these same example configurations of a redundant control system can be applied to BLDC motors that drive their own respective shafts S1 and S2 as per FIG. 4.

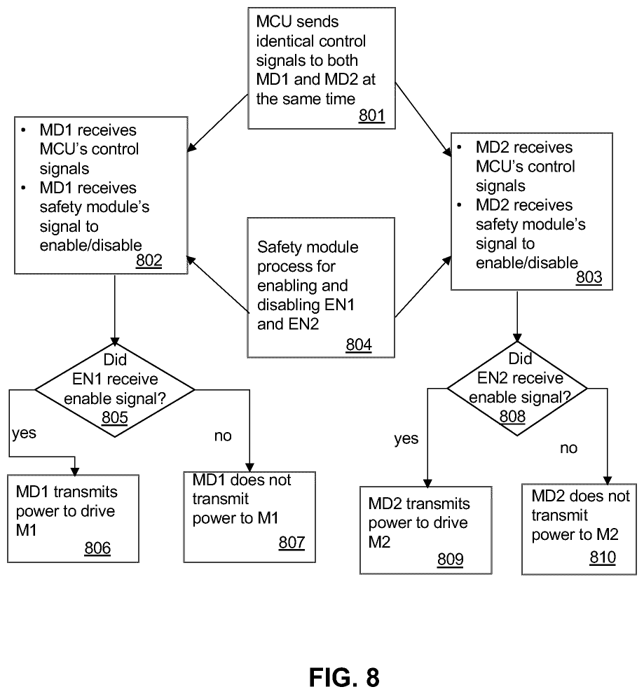

Turning to FIG. 8, an example embodiment of executable instructions is provided for the redundant control system. At block 801, the MCU sends identical control signals to both motor drivers at the same time. In this way, as per block 802 and 803, both motor drivers receive control signals from the MCU at the same time to process the same and to generate current outputs for each coil in their respective BLDC motors. At the same time, the safety module executes a computing process to send an enable signal to one of the enable modules EN1 and EN2 so that one of the motor drivers drives current and the other motor drives does not drive current.

In an example aspect, the digital signal sent by the MCU to the first motor driver MD1 and the digital signal sent to the second motor driver MD2 are considered companion signals. For example, if the first BLDC motor and the second BLDC motor are meant to operate identically, then the digital signals sent by the MCU to both the first and the second motor drivers are identical and synchronized. In another example, if the first BLDC motor and the second BLDC motor are physically out of phase, then the then the digital signals sent by the MCU to both the first and the second motor drivers are identical and are purposely out of phase. It can be appreciated that there can be other mappings between the digital signals that correspond to the physical mappings between the first BLDC motor and the second BLDC motor, such that a fault in one motor will automatically trigger the second motor to activate with little or no detectable loss of performance of the physical motive system.

In an example aspect, if the module EN1 is enabled at block 805, then the first motor driver transmits power to drive the first BLDC motor M1 (block 806). Otherwise, if the module EN1 is disabled, then the first motor driver does not transmit power to the first BLDC motor M1 (block 807).

In another example aspect, if the module EN2 is enabled at block 808, then the second motor driver transmits power to drive the second BLDC motor M2 (block 809). Otherwise, if the module EN2 is disabled, then the second motor driver does not transmit power to the second BLDC motor M2 (block 810).

In other words, the motor M1 is powered by the motor driver MD1, and the motor driver MD1 is controlled by a first enable signal that controls a first current output of the motor driver MD1. The motor M2 is powered by the motor driver MD2, and the motor MD2 is controlled by a second enable signal that controls a second current output of the motor driver MD2. The safety module obtains data about an operating parameter of at least one of the motors MD1 and MD2 to control the first enable signal and the second enable signal so that only one of the motors MD1 and MD2 are driven at a same time.

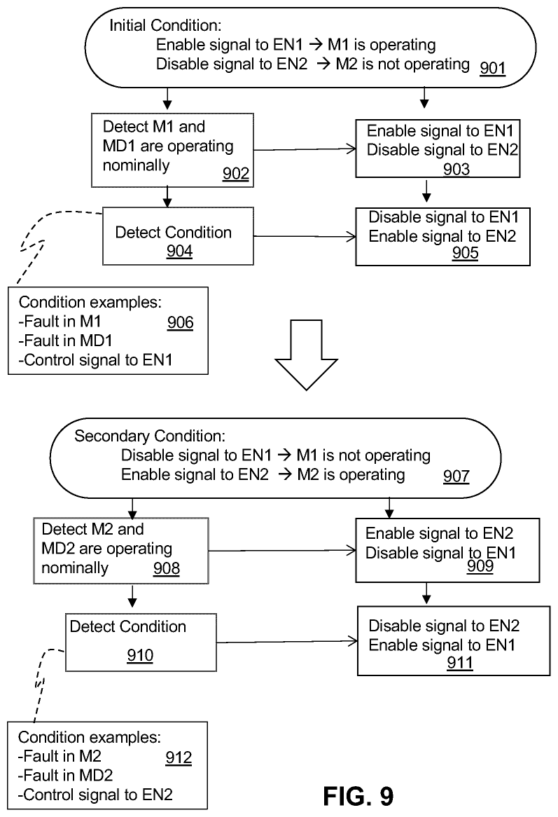

FIG. 9 shows an example embodiment of the safety module implementing block 804. At the initial condition 901, the enable signal to the first motor driver (or more specifically to the enable module EN1) is sent by the safety module so that the first BLDC motor M1 is operating, and the enable signal to the second motor driver (or more specifically to the enable module EN2) is disabled by the safety module so that the second BLDC motor M2 is not operating.

At block 902, the safety module detects that the first BLDC motor M1 and the first motor driver are operation nominally. Accordingly, the initial condition of enabling the first motor driver to transmit current and disabling the second motor driver from transmitting current is maintained (block 903).

At block 904, the safety module detects a certain condition, and responsive to the detected condition, the safety module transmits a disable signal to first motor driver MD1 (via module EN1) and transmits an enable signal to the second motor driver MD2 (via module EN2). For example, the condition includes one or more of: a fault condition in the first BLDC motor M1, a fault condition in the first motor driver, and a control signal to initiate a switch from the first BLDC motor to the second BLDC motor (block 906). For example, the fault condition in the first BLDC motor could related to an out-of-synchronous signal from one or more Hall effect sensors. Other example fault conditions include an over-temperature condition, an over-current condition, and under-voltage condition. The fault condition may also originate from an external data source 504.

For example, if there is a fault or an anomaly in the control or operation of the first BLDC motor, then automatically and nearly instantaneously the safety module switches to the second BLDC motor by transmitting a disable signal to EN1 and transmitting an enable signal to EN2. As the computations and processes were and are already being made to control the second motor driver, the output signals are concurrently and continuously being sent to the second motor driver. In this way, the second BLDC motor M2, when its movement is enabled, tracks or replaces the exact same expected movements of the first BLDC motor M1. Accordingly, there is no loss of control of the shaft or drive system. In other words, the implementation of the redundancy is immediate to provide continuous control of the shaft or drive system.

It will also be appreciated that the switch from the first BLDC motor to the second BLDC motor does not necessarily need to be triggered by a detected fault. For example, the MCU could use some other condition (e.g. a user input, an external sensor condition, etc.) to trigger sending a control signal to the safety module to trigger the switch between BLDC motors.

After transmitting a disable signal to the module EN1 and transmitting an enable signal to the module EN2, a secondary state 907 of the system includes the first BLDC motor M1 in a non-operating state and the second BLDC motor M2 in an operating state.

In response to detecting that the second BLDC motor and the second motor driver are operating nominally (block 908), the secondary state is maintained (block 909).

In a further example aspect, in response to detecting a certain condition at block 910, the safety module then transmits a disable signal to the module EN2 and transmits an enable signal to the module EN1 (block 911). This returns the system state back to the initial condition 901.

In an example aspect, the certain condition detected at block 910 includes any one or more of: a fault condition in the second BLDC motor M2, a fault condition in the second motor driver, and a control signal to switch (block 912).

In the example of FIG. 9, one BLDC motor is operational at a given time.

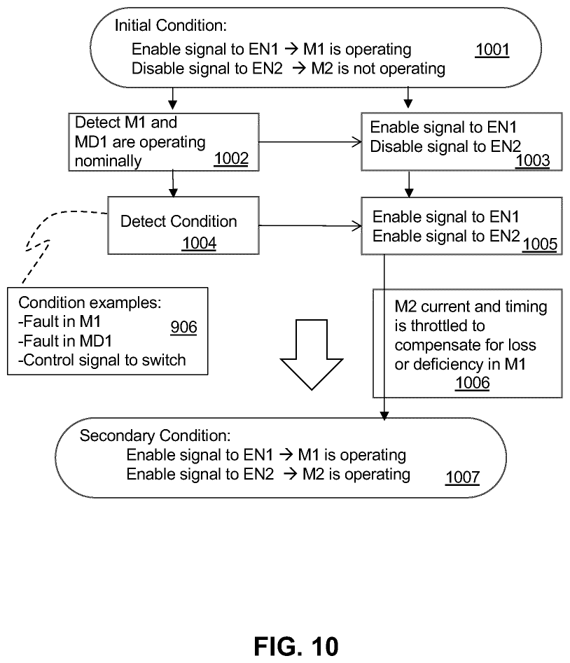

FIG. 10 shows an alternative example implementation for block 806 in which two BLDC motors are operating at the same time. At the initial condition 1001, the safety module sends an enable signal to the motor driver MD1 (via the module EN1) and sends a disable signal to the motor driver MD2 (via the module EN2). If the first BLDC motor and the first motor driver are operating nominally (block 1002), then the initial condition 1003 is maintained.

Responsive to detecting a certain condition at block 1004, the safety module sends an enable signal to the motor driver MD2 (via the module EN2) so that both motor drivers MD1 and MD2 are enabled to drive current to the motors M1 and M2, respectively (block 1005).

In an example aspect, if the first BLDC motor is not operating at full power or efficiency, then the second BLDC motor is enabled to compensate, so that the combined output of the first BLDC motor and the second BLDC motor driving a shaft satisfies the desired output of the control system (block 1006). For example, the current output and timing of the second motor driver to the second BLDC motor are adjusted to compensate for any deficiencies in the output of the first BLDC motor. This is a form of load balancing.

In another example embodiment, there is no deficiency in the first BLDC motor or the first motor driver. The second module EN2 is enabled so as to increase the power applied to the drive system beyond the first BLDC motor.

Therefore, the secondary state 1007 includes both BLDC motors operating. In other words, the motor drivers are coordinated so that both BLDC motors are being driven at the same time.

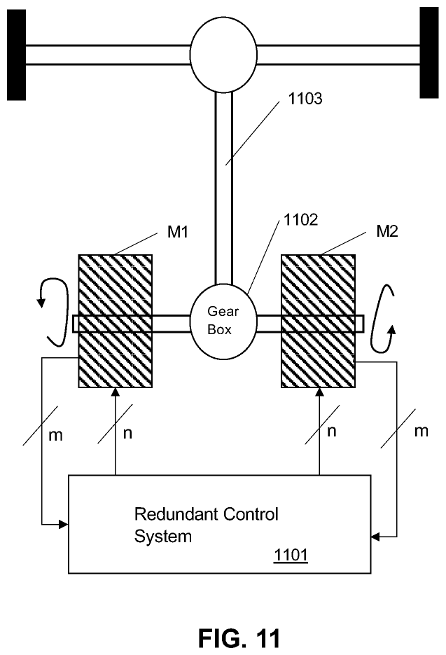

FIG. 11 shows another example embodiment in which redundant BLDC motors M1 and M2 are connected to their respective shafts, and these shafts are coupled to a gear box 1102. The gear box in turn drives a main shaft 1103. For example, when the first BLDC motor M1 spins clockwise, then the gear box drives the main shaft in the clockwise direction. When the second BLDC motor M2 spins in an opposite direction (e.g. counter clockwise), then the gear box drives the main shaft in the same clockwise direction to provide redundancy.

The redundant control system 1101 drives one motor at a time. For example, if a certain condition is detected (e.g. a fault condition) in relation to the first motor M1, then the second motor M2 is automatically enabled while the first motor M1 is disabled. However, due to the gear box 1102, the second motor M2 is controlled to spin in an opposite direction so that the output on the main drive shaft 1103 is controlled in the same way as when the first motor M1 was driving the main drive shaft 1103.

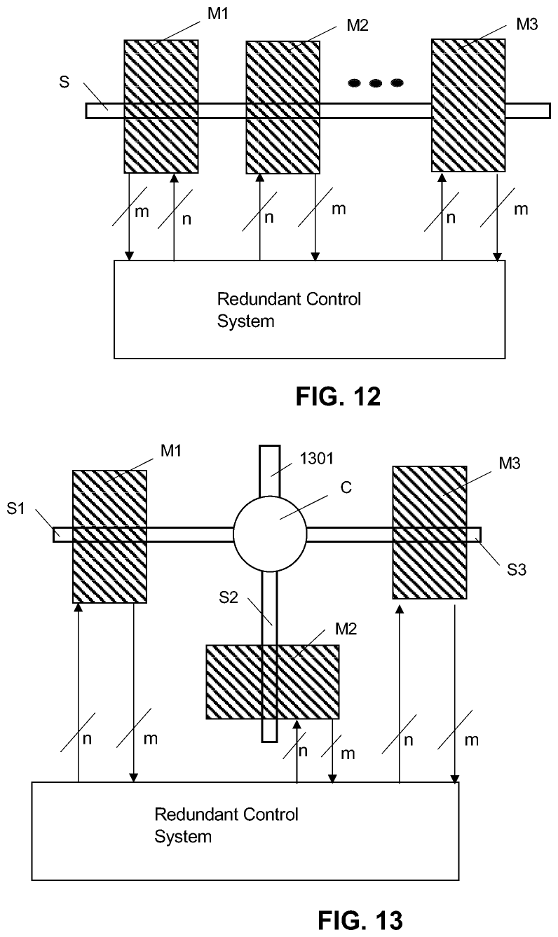

It will be appreciated that the redundant control system embodiments described above, which drive two power control systems respectively for two BLDC motors, is also applicable to control a larger number of redundant systems. For example, as shown in FIG. 12, three or more BLDC motors M1, M2, M3, etc. coupled to and are able to drive a common shaft. In an example embodiment, one of the motors is activated at a time, while the other motors are provided for secondary and tertiary redundancy.

FIG. 13 shows another example embodiment in which three BLDC motors M1, M2 and M3 drive their respective shafts S1, S2 and S3, and these shafts are coupled together with a coupling C. The coupling C is then coupled to drive a main shaft 1301. The redundant control system drives one or more of the motors M1, M2 and M3 at any given time to ensure high reliability to drive the main shaft 1301.

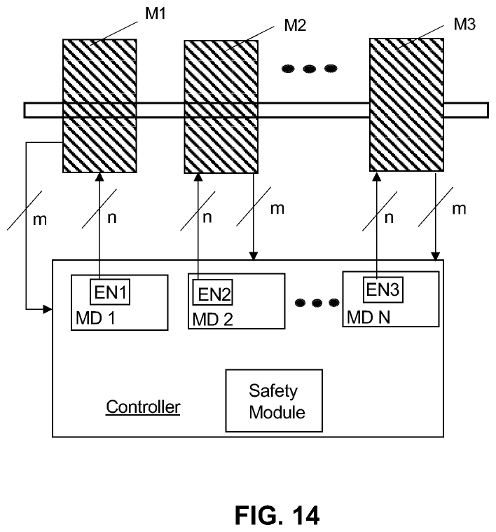

An example embodiment of a redundant control system of multiple BLDC motors M1, M2, M3 that are coupled to a common shaft S is shown in FIG. 14. The system includes each multiple power control systems that respectively drive each BLDC motor, and each of the multiple control systems include an enable switch.

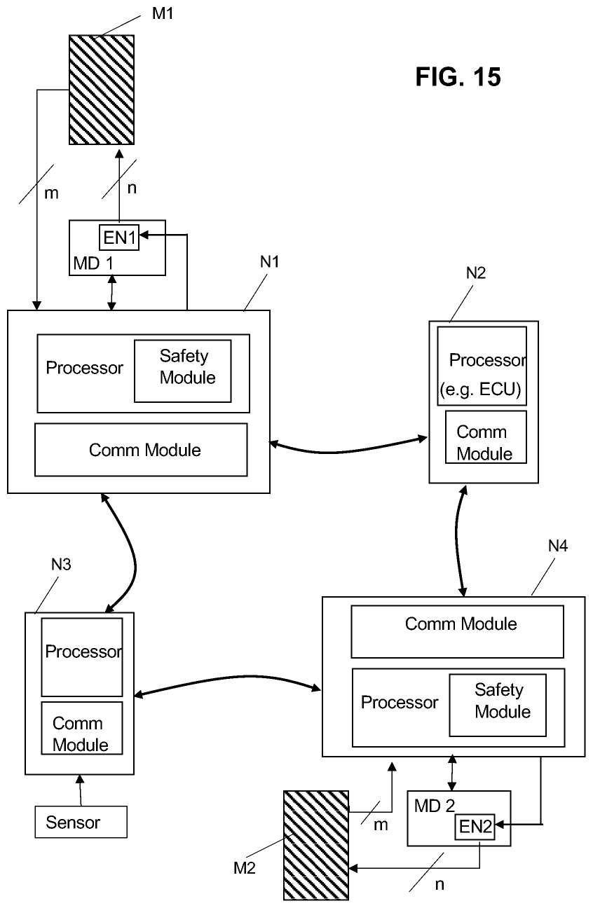

Turning to FIG. 15, a system is shown that includes at least two nodes N1 and N4 that each have connected to them a motor driver and a BLDC motor. The nodes N1 and N4 are networked together. The node N1 and the node N4 respectively compute and transmit digital signals to their respective motor drivers, wherein the digital signals computed by the node N4 control its own motor driver to drive the own BLDC motor in a motion redundant to the BLDC motor of the first node. The nodes N1 and are coordinated through the network to respectively control their motor drivers so that only one of the BLDC motors is driven at a same time.

In an example aspect, there may be additional nodes in the network, such as nodes N2 and N3. These nodes are wired together in a ring communication formation. For example, nodes N1 and N2 have a communication wire extending therebetween; nodes N2 and N4 have a communication wire extending therebetween; nodes N3 and N4 have a communication wire extending therebetween; and nodes N1 and N3 have a communication wire extending therebetween. In an example embodiment, the communication wire is an Ethernet cable. The number of nodes in the network and the shape of the network can vary.

These nodes each include a processor and a communication module, amongst other things. In an example embodiment, these are different nodes in a car, or other vehicle system, or some other mechanical system, and these nodes are physically spread apart from each other.

The nodes N1 and N4 each include processors that include a safety module. In particular, the safety module in N1 controls the enable module EN1 in the first motor driver MD1, which in turn drives the first BLDC motor M1. The safety module in N4 controls the enable module EN2 in the second motor driver MD2, which in turn drives the second BLDC motor M2.

It will be appreciated that the motor M1 and the motor M2 are a redundant pair of motors, whereby one of these motors is enabled at any given time. In other words, the nodes N1 and N4 are companion nodes. It will be appreciated that if the motor M1 fails, the redundant motor M2 is enabled to take the place of the motor M1.

The node N3 is, for example, includes one or more sensors, such as camera, radar or some other sensor.

Data flows across all the nodes in the network in a redundant path. In other words, if the communication wire between the nodes N1 and N2 is removed or damaged, then data the node N1 can still propagate to the node N4 via the node N3.

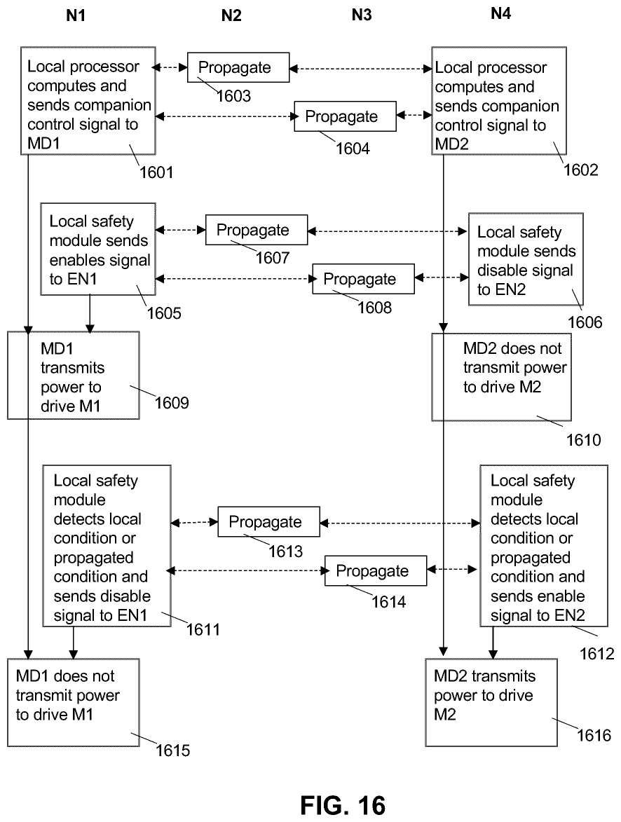

FIG. 16 shows an example process of the nodes N1, N2, N3 and N4 from the system in FIG. 15. In particular, the node N1's local processor computes and sends a companion signal to its connected motor driver MD1 (block 1601). At the same time, the node N4's local processor computes and sends a companion signal to its connected motor driver MD2 (block 1602). In an example aspect, the companion signal of the node N4 compared to the companion signal of the node N1, for example, is identical and synchronized, such as when the motors M1 and M2 are positioned and oriented to drive an output shaft in nearly identical ways (e.g. both motors M1 and M2 are positioned on the same drive shaft and have the same phase orientation). In an alternative example aspect, the motors M1 and M2 are on the same drive shaft, but are out of phase with each other, so that the companion control signals computed at each local processor in node N1 and in node N4 are also out of phase with each other.

In an example aspect, the local processor signals at N1 and N4 are coordinated with each other, such that if the enabled first motor M1 fails, then the second motor M2 is immediately enabled and activated to continue off from the last position and motion of the first motor M1. This provides a continuous transition from a primary motor to a back-up motor. In an example aspect, the local processor signals are propagated across the redundant communication network (e.g. redundant Ethernet cable network). For example, signals from N1 travel to N2, and then propagate (block 1603) from N2 to N4; and vice versa. In addition, signals from N1 travel to N3, and then propagate (block 1604) from N3 to N4; and vice versa.

It will also be appreciated the operations in blocks 1601 and 1602 at each of the location processors are continuous.

At block 1605, the local safety module in the node N1 transmits an enable signal to the module EN1. Similarly, the companion safety module in the node N4 transmits a disable signal to the module EN2 (block 1606). The enable module status at each node is propagated via nodes N2 and N3 (blocks 1607 and 1608).

At the node N1, the first motor driver MD1 receives the enable signal from its local safety module and the digital signal from its local processor, and then the first motor driver transmits power to drive the first motor M1 (block 1609). Accordingly, at the same time at the node N4, the second motor driver MD2 receives the disable signal from its local safety module and the digital signal from its local processor, and then the second motor driver does not transmit power to drive the second motor M2 (block 1610). In other words, in a nominal condition, the first motor M1 is enabled and the second motor M2 is disabled.

A condition is then detected at any one of nodes N1, N2, N3 and N4 and is propagated across the system of nodes. In other words, at block 1611, the local safety module of the node N1 detects a local condition or a propagated condition and then sends a disable signal to EN1. At block 1612, the local safety module of the node N4 detects a local condition or a propagated condition and then sends an enables signal EN2. The propagation of the detected condition can spread across the nodes using one or more of the available paths.

The blocks 1611 and 1612 happen at the same time or within a very short time range (e.g. in the order of microseconds). Responsive to the disabled signal received at EN1, at block 1615, the first motor driver MD1 does not transmit power to drive the first motor MD1. In other words, the first motor driver MD1 stops transmitting power to drive the first motor MD1. Responsive to the enable signal received at EN2, at block 1616, the second motor driver MD12 transmits power to drive the second motor MD2.

Even during the operations at block 1615 and 1616, the local processors at the nodes N1 and N4 continue to compute and send companion signals to the connected motor drivers MD1 and MD2 in a coordinated manner.

In an example embodiment, the network is in a vehicle and, in a further example aspect, one of the nodes is an electronic control unit (ECU). For example, N2 is an ECU.

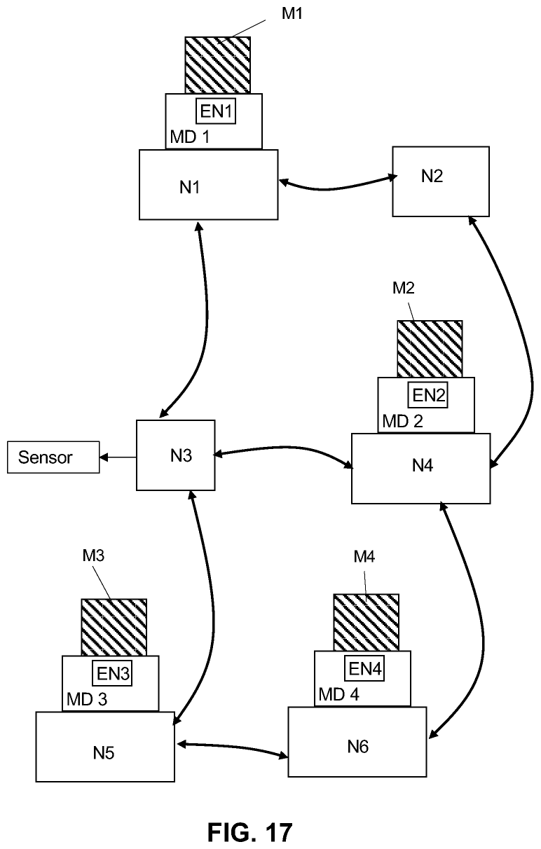

FIG. 17 is similar to the system of nodes shown in FIG. 15. However, FIG. 17 further shows two additional nodes N5 and N6. The node N5 has its own processor and safety module and it controls the third motor driver (referred herein as MD3), the third enable module EN3 and the third BLDC motor M3. The node N6 has its own processor and safety module and it controls the fourth motor driver (referred herein as MD4), the fourth enable module EN4 and the fourth BLDC motor M4.

The motors M3 and M4 are companion motors that form a redundant pairing, including with their related components. For example, the third BLDC motor M3 is enabled while the fourth BLDC motor M4 is not enabled. If a condition is detected in relation to the third BLDC motor M3, then: the third BLDC motor is disabled and the fourth BLDC motor is enabled.

These signals can pass directly from the node N5 to N6. Alternatively, if the communication wire between N5 and N6 is cut or damaged, then the coordinating signal between N5 and N6 is still propagated therebetween using another wired path (e.g. N5 to N3, N3 to N1, N1 to N2, N2 to N4, and N4 to N6).

In other words, using the same network of wires, different companion or coordination signals can be sent amongst the nodes. In this example, data to establish the companion pairing between the nodes N1 and N4 is propagated amongst the system of nodes; and data to establish the companion pairing between the nodes N5 and N6 is propagated amongst the same system of nodes.

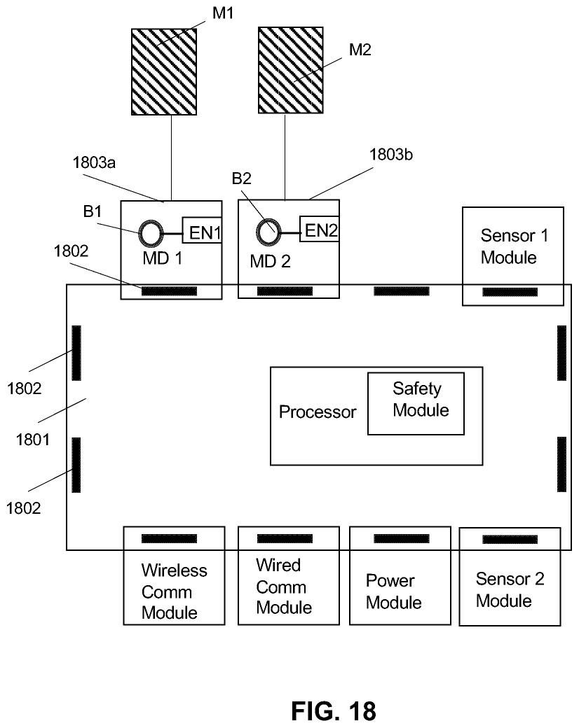

Turning to FIG. 18, an example kit of parts is provided for implementing the redundant control system, such as for development and testing applications. The kit includes a main board 1801 that has slots 1802 for data communication and power. The kit also includes two or more motor driver boards 1803a, 1803b that can connect to the main board 1801 via the slots 1802. Each board has a physical button or a physical switch (i.e. B1 on the board 1803a, and B2 on the board 1803b), that directly controls the enable module on the same board. For example, pressing a button B1 disables the module EN1 on the board 1803a, which in turn cuts off the current supply to the motor M1. For example, the button B1 is used to manually simulate a fault condition to the motor M1.

The kit also includes other peripheral board that can connect to the main board, such as a sensor module, a power module and a communication module. The communication module can be a wireless communication module or a wired communication module. In another example aspect, the kit includes a wireless communication module and a wired communication module.

The main board 1801 includes thereon a processor (e.g. MCU, DSP chip, FPGA, etc.) and a safety module.

The kit can be assembled as shown in FIG. 18 to test and develop a redundant control system for redundantly controlling two or more BLDC motors.

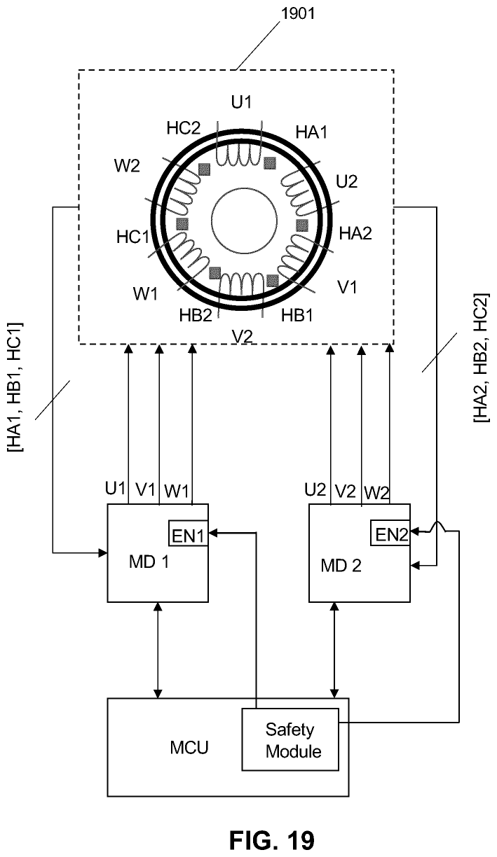

Turning to FIG. 19, another example embodiment of a redundant control system is provided. While the above examples show multiple BLDC motors, in this example, there is one motor. However, this motor has the redundancy internally built in while still allowing for separate control of the coils.

In particular, the motor 1901 includes one stator and one rotor. Two separate sets of coils, with each coil set including three coils, are mounted to the stator. In other words, a total of six coils are mounted to the stator. Coils U1, V1, W1 form a first coil set and coils U2, V2, W2 form a second coil set.

The first motor driver MD1 outputs power to the first coil set (U1, V1, W1) and the second motor driver MD2 outputs power to the second coil set (U2, V2, W2). The first coil set and the second coil set are out of phase from each other around the stator. Therefore, the digital control signals for the second coil set is computed by the MCU to take on the next position of the rotor relative to the activation provided by the first coil set. In other words, although the first coil set and the second coil set are redundant companions, the MCU control signals are out of phase with each other.

It is appreciated however, that as in the above examples, while the MCU computes and simultaneously transmits digital control signals to all motor drivers including the redundant motor drivers, the enable modules EN1, EN2 in the redundant motor drivers are not enabled unless a certain condition is met.

Therefore, in an example embodiment, the first coil set is energized as the enable module EN1 is enabled, while the second coil set is not energized as the enable module EN2 is disabled. Responsive to detecting a condition and the safety module sending a disable signal to EN1 and an enable signal to EN2, the first coil set stops being energized and the second coil set starts being energized according to the next MCU digital control signal, which has already been computed and sent to the second motor driver.

Below are general example embodiments and example aspects.

In a general example embodiment, a redundant BLDC motor control system is provided, comprising: a first BLDC motor powered by a first motor driver, the first motor driver controlled by a first enable signal that controls a first current output of the first motor driver; a second BLDC motor powered by a second motor driver, the second motor controlled by a second enable signal that controls a second current output of the second motor driver; a digital processor system that computes and simultaneously transmits first digital signals to the first motor driver and second digital signals to the second motor driver, wherein the second digital signals control the second motor driver to drive the second BLDC motor in a motion redundant to the first BLDC motor; and a safety module that obtains data about an operating parameter of at least one of the first BLDC motor and the second BLDC motor to control the first enable signal and the second enable signal to coordinate control of the first BLDC motor and the second BLDC motor at a same time.

In an example aspect, the safety module coordinates the control of both the first BLDC motor and the second BLDC motor being driven at the same time

In an example aspect, the safety module coordinates the control of only one of the first BLDC motor and the second BLDC motor being driven at the same time.

In an example aspect, responsive to detecting from the data that the first motor driver and the first BLDC motor are operating nominally, the safety module transmits the first enable signal to drive the first BLDC motor.

In an example aspect, responsive to detecting from the data a fault condition in relation to at least one of the first motor driver and the first BLDC motor, the safety module transmits the second enable signal to drive the second BLDC motor. In an example aspect, the fault condition is an out-of-position parameter from a Hall effect sensor in the first BLDC motor. In an example aspect, the fault condition is one of: an over-temperature reading, an over-current reading and an under-voltage reading.

In an example aspect, responsive to detecting from the data a faulty operating parameter related to the first BLDC motor, the safety module transmits the second enable signal to drive the second BLDC motor; and wherein the faulty operating parameter originates from a device external to the first BLDC motor.

In an example aspect, the device external to the first BLDC motor is an external sensor.

In an example aspect, the digital processor system is a microcontroller, and the microcontroller includes the safety module.

In an example aspect, a common shaft extends through both a first stator of the first BLDC motor and a second stator of the second BLDC motor; and, in an initial condition, the first BLDC motor driving the common shaft while the second BLDC motor is not driven; and, responsive to detecting a fault condition, the safety module transmits the second enable signal to the second BLDC motor to drive the common shaft instead of the first BLDC motor.

In an example aspect, the first BLDC motor and the second BLDC motor are mechanically coupled to a common drive mechanism; and, in an initial condition, the first BLDC motor drives the common drive mechanism while the second BLDC motor is inactive.

In an example aspect, the first digital signals and the second digital signals are identical and are synchronized.

In an example aspect, the first digital signals and the second digital signals are out of phase from each other.

In an example aspect, the first BLDC motor is a primary actuator for a vehicle's steering system, and the second BLDC motor is a redundant actuator for the vehicle's steering system.

In an example aspect, the first BLDC motor is a primary driver for one or more wheels of a vehicle, and the second BLDC motor is a redundant driver for the one or more wheels of the vehicle.

In an example aspect, the first BLDC motor and the second BLDC motor are each three-phase motors.

In another general example embodiment, a network system is provided comprising: a first node controlling a first motor driver, and the first motor driver driving a first BLDC motor; a second node controlling a second motor driver, and the second motor driver driving a second BLDC motor; the first node and the second node are in wired data communication with each other; wherein the first node and the second node compute and respectively transmit first digital signals to the first motor driver and second digital signals to the second motor driver, wherein the second digital signals control the second motor driver to drive the second BLDC motor in a motion redundant to the first BLDC motor; and the first node and the second node are coordinated through the network to respectively control the first motor driver and the second motor driver at a same time.

In an example aspect, the first node and the second coordinate the control of both the first BLDC motor and the second BLDC motor to be driven at the same time.

In another example aspect, the first node and the second node coordinate the control of only one of the first BLDC motor and the second BLDC motor to be driven at the same time.

In an example aspect, the network system is a redundant network and data exchanged between the first node and the second node is transmittable along more than one path.

In an example aspect, the network system is a redundant network that further comprises one or more intermediary communication nodes, and data exchanged between the first node and the second node is transmittable along more than one path that includes the one or more intermediate communication nodes.

In an example aspect, the network system is a redundant ethernet network.

In an example aspect, any one of the first node and the second node detect a fault condition that initiates switching from driving the first BLDC motor to driving the second BLDC motor, or switching from driving the second BLDC motor to driving the first BLDC motor.

In an example aspect, the fault condition is propagated to every node in the network system.

In an example aspect, the first BLDC motor and the second BLDC motor drive a common shaft.

In an example aspect, the first BLDC motor drives a first shaft and the second BLDC motor drives a second shaft, and the first shaft and the second shaft are coupled together.

In an example aspect, the first BLDC motor and the second BLDC motor are each three-phase motors.

In an example aspect, the first BLDC motor and the second BLDC motor each have more than three phases.

In an example aspect, the first node comprises a first safety module that transmits a first enable signal to the first motor driver, wherein the first enable signal controls a first current output of the first motor driver; and the second node comprises a second safety module that transmits a second enable signal to the second motor driver, wherein the second enable signal controls a second current output of the second motor driver.

In an example aspect, the first digital signals and the second digital signals are identical and are synchronized.

In an example aspect, the first digital signals and the second digital signals are out of phase from each other.

In another general example embodiment, a vehicle is provided comprising: a network system that comprises a first node controlling a first motor driver, the first motor driver driving a first BLDC motor, and a second node controlling a second motor driver, the second motor driver driving a second BLDC motor; the first node and the second node are in wired data communication with each other; wherein the first node and the second node compute and respectively transmit first digital signals to the first motor driver and second digital signals to the second motor driver, wherein the second digital signals control the second motor driver to drive the second BLDC motor in a motion redundant to the first BLDC motor; and the first node and the second node are coordinated through the network to respectively control the first motor driver and the second motor driver at a same time.

In an example aspect, the network further comprises an electronic control unit (ECU) that is in wired data communication with the first node and the second node.

In another general example embodiment, a redundant BLDC motor control system is provided, comprising: a BLDC motor comprising a first set of coils powered by a first motor driver, and a second set of coils powered by a second motor driver; the first motor driver controlled by a first enable signal that controls a first current output by the first motor driver, and the second motor driver controlled by a second enable signal that controls a second current output by the second motor driver; a digital processor system that computes and simultaneously transmits first digital signals to the first motor driver and second digital signals to the second motor driver; and a safety module that obtains data about an operating parameter of at least one of the BLDC motor, the first motor driver and the second motor driver, to control the first enable signal and the second enable signal to coordinate control of the first current output and the second current output.

It is appreciated that MCUs are used in the examples provided herein. However, other types of digital processor can be used, including DSP chips and FPGAs.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, EEPROM, flash memory or other memory technology, optical storage, magnetic disk storage or other magnetic storage devices, or any other medium which can be used to store the desired information and which can be accessed by an application, module, or both. Any such computer storage media may be part of the servers or computing devices or nodes, or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1-16. (canceled)

17. A network system comprising:
a first node controlling a first motor driver, and the first motor driver driving a first brushless direct current (BLDC) motor;
a second node controlling a second motor driver, and the second motor driver driving a second BLDC motor;
the first node and the second node are in wired data communication with each other;
wherein the first node and the second node compute and respectively transmit first digital signals to the first motor driver and second digital signals to the second motor driver, wherein the second digital signals control the second motor driver to drive the second BLDC motor in a motion redundant to the first BLDC motor; and
the first node and the second node are coordinated through the network system to respectively control the first motor driver and the second motor driver at a same time.

18. The network system of claim 17 wherein the first node and the second coordinate the control of both the first BLDC motor and the second BLDC motor to be driven at the same time.

19. The network system of claim 17 wherein the first node and the second node coordinate the control of only one of the first BLDC motor and the second BLDC motor to be driven at the same time.

20. The network system of claim 17 wherein the network system is a redundant network and data exchanged between the first node and the second node is transmittable along more than one path.

21. The network of claim 17 wherein the network system is a redundant network that further comprises one or more intermediary communication nodes, and data exchanged between the first node and the second node is transmittable along more than one path that includes the one or more intermediate communication nodes.

22. The network of claim 17 wherein the network system is a redundant ethernet network.

23. The network system of claim 17 wherein any one of the first node and the second node detect a fault condition that initiates switching from driving the first BLDC motor to driving the second BLDC motor, or switching from driving the second BLDC motor to driving the first BLDC motor.

24. The network system of claim 23 wherein the fault condition is propagated to every node in the network system.

25. The network system of claim 17 wherein the first BLDC motor and the second BLDC motor drive a common shaft.

26. The network system of claim 17 wherein the first BLDC motor drives a first shaft and the second BLDC motor drives a second shaft, and the first shaft and the second shaft are coupled together.

27. The network system of claim 17 wherein the first node comprises a first safety module that transmits a first enable signal of the first motor driver, wherein the first enable signal controls a first current output of the first motor driver; and the second node comprises a second safety module that transmits a second enable signal to the second motor driver, wherein the second enable signal controls a second current output of the second motor driver.

28. The network system of claim 17 wherein the first digital signals and the second digital signals are identical and are synchronized.

29. The network system of claim 17 wherein the first digital signals and the second digital signals are out of phase from each other.

30. A vehicle comprising:
a network system that comprises a first node controlling a first motor driver, the first motor driver driving a first brushless direct current (BLDC) motor, and a second node controlling a second motor driver, the second motor driver driving a second BLDC motor;
the first node and the second node are in wired data communication with each other;
wherein the first node and the second node compute and respectively transmit first digital signals to the first motor driver and second digital signals to the second motor driver, wherein the second digital signals control the second motor driver to drive the second BLDC motor in a motion redundant to the first BLDC motor; and
the first node and the second node are coordinated through the network system to respectively control the first motor driver and the second motor driver at a same time.

31. The vehicle of claim 30 wherein the network system further comprises an electronic control unit (ECU) that is in wired data communication with the first node and the second node.

32. (canceled)
